(19) United States
(12) Patent Application Publication
(10) Pub. No.: US 2006/0042706 A1
(43) Pub. Date: Mar. 2, 2006

(54) Modular drinks dispenser

(76) Inventors: Keith S Perry, Walsall (GB); Paul A Deane, West Midlands (GB); Christopher R Gregson, Derbyshire (GB)

Correspondence Address: INTELLECTUAL PROPERTY / TECHNOLOGY LAW, PO BOX 14329, RESEARCH TRIANGLE PARK, NC, 27709, US

(21) Appl. No.: 10/536,500

(22) PCT Filed: Nov. 11, 2003
(86) PCT No.: PCT/IB03/05084

§ 371 Date: Aug. 15, 2005

(30) Foreign Application Priority Data
Nov. 27, 2002 (GB) 0227627.7

(51) Int. Cl. F15B 13/00; F16K 1/00

(52) U.S. Cl. 137/884

(57) ABSTRACT

This invention relates to a drinks dispenser, and in particular to a drinks dispenser suitable for use at commercial premises such as a bar or public house for serving beer and the like. According to the invention there is provided a drinks dispenser comprising a frame (14) carrying at least one tap (20), the frame being connected to a column (12) within which can be located a conduit (52) for delivering liquid to the tap, the frame having connectors (30) by which separate and additional frame(s) (16) may be connected thereto, a separate cover (76) being provided which can be mounted upon the frame means. The drinks dispenser is therefore modular in construction, with the frame(s) providing the structural strength of the dispenser and the cover(s) fulfilling the aesthetic requirements.

### FIELD OF THE INVENTION

This invention relates to a drinks dispenser, and in particular to a drinks dispenser suitable for use at commercial premises such as a bar or public house for serving beer and the like.

In the following description, for brevity reference is made to the drinks dispenser in use for the dispensing of beer, but it will be understood that the dispenser is equally suitable for other alcoholic and non-alcoholic drinks.

Some of the terminology used in the drinks supply industry is not commonised, but reference is made herein to the “tap” as that component through which the beer or other drink is dispensed. The tap may for example be manually controlled by way of a lever, or may comprise a valve which is electrically controlled. Also, the term “dispense head” is used to refer to the structure comprising the tap, its associated controls, and the housing within or upon which the tap is mounted.

### DESCRIPTION OF THE PRIOR ART

Traditional drinks dispensers for beer employed a dispense head secured to a serving counter, the dispense head having a tap connected to one end of a (usually flexible) conduit, the other end of the conduit being connected to the barrel containing the beer.

The dispense head is usually in the form of a housing which bears the name, logo and other indicia of the beer supplier or producer, so that the beer available from that tap could be identified by the customer and bartender.

In an alternative arrangement, often referred to as a “tower”, several dispense heads (each with its own tap) are connected together as a single housing, the conduits for each tap being located within a column of the housing.

Both of these arrangements are in widespread use, with the alternative “tower” arrangement becoming increasingly popular since each dispense head occupies less counter space so that more dispense heads can be provided on the counter, allowing more beer (and other drinks) to be dispensed.

A particular disadvantage of tower arrangements is, however, that if the number of dispense heads is to be increased or decreased the whole tower will need to be replaced with another tower having more or fewer dispense heads and associated pipework. Because of their complexity tower drinks dispensers are expensive, and a removed tower can rarely be re-used. Also, tower drinks dispensers are sufficiently complex that their removal and replacement is a task normally only undertaken by a service engineer.

A modular tower drinks dispenser is disclosed in GB Patent Application 2,178,729. In that document the dispense heads are modular, and a number of separable dispense heads are carried by a central column and housing. The dispense heads are held together either by dowels or cooperating beads and grooves. It is not clear from this document how a tap is mounted to a dispense head, nor how each beer-supply conduit is connected to its respective tap. It is believed that the disclosed drinks dispenser has never been commercialised, perhaps because of an inadequate disclosure, or perhaps because the structure is not sufficiently robust to withstand the loads carried by the dispense heads, in particular the outermost dispense heads most remote from the central column. In this latter regard it is doubted that the dowel connections, or the cooperating bead and groove connections, between adjacent dispense heads, could withstand the loading which might be placed upon the outermost sections as beer is being dispensed, during which activity the server may apply significant force to the dispense head by way of the tap.

### SUMMARY OF THE INVENTION

It is an object of the present invention to provide a drinks dispenser which avoids or reduces the above-stated problems.

According to the invention, there is provided a drinks dispenser comprising a frame means carrying at least one tap, the frame means being connected to a column within which can be located a conduit for delivering liquid to the tap, the frame means having connecting means by which separate and additional frame means may be connected thereto, characterised in that a separate cover means is provided which can be mounted upon the frame means.

Therefore, in the invention the cover means is separate to the frame means, the cover having the decoration and indicia of the liquid being dispensed, and being removably mounted upon the frame means, with the frame providing the structural strength of the dispenser and in particular providing the means by which additional taps may be mounted thereupon.

Usefully, the column of the drinks dispenser is fitted with several conduits, the number of conduits being chosen as the maximum number of dispense heads which can be mounted to the dispenser. If desired, each conduit can be fitted with a connector at each end so that its respective ends can be connected to a tap and liquid supply conduit respectively, if required. Typically, the fitted conduit would extend beyond the top of the column sufficiently to connect to a tap carried by the unit, and would extend beyond the bottom of the column sufficiently to be connected to a (usually pre-existing) liquid supply conduit underneath the counter.

The connections between the tap and the conduit, and the connections between the fitted conduit and the liquid supply conduit, are preferably provided by proprietary fluid-tight connectors, for example John Guest(™) connectors.

Preferably, the column also carries a coolant supply conduit and a coolant exhaust conduit, it being desired to provide coolant to the liquid supply lines within the column. Preferably also, the column carries a coolant supply manifold and a coolant exhaust manifold, each manifold having a number of branch means through which coolant can pass towards a respective dispense head. When a new or further tap is fitted to the unit, a coolant conduit can be connected between the coolant supply manifold and the coolant exhaust manifold, and can be configured to lie alongside the liquid supply conduit between the column and the tap, so that the liquid is cooled substantially all of the way to the tap.

Thus, in liquids which are served chilled, it is desirable to provide a coolant supply as close to the tap as possible, since the liquid within any part of the liquid supply conduit which is not cooled would warm up during the period when that liquid is not being dispensed. This might require the tap to be opened so as to discharge any warmed liquid from the supply conduit, before cooled liquid is available. Clearly, if the liquid supply conduit is cooled substantially all the way to the tap the likelihood of any of the liquid becoming warmed is lessened, and so the wastage of warmed liquid is reduced.

In a dispenser adapted to carry five dispense heads, each manifold could carry four branch means (branch means typically not being required for the central dispense head). If the publican has fewer than five dispense heads connected to such a dispenser, the spare branch means must be plugged to prevent leakage of coolant, and the spare conduits should be plugged to prevent dirt ingress.

Preferably, each frame means and/or cover means carries illuminating means. Preferably also, each frame means and/or cover means carries electrical wiring means to interconnect its illuminating means with that of its neighbours. In this way, the lighting of the dispenser is modular, an illuminating means being provided for each dispense head.

Desirably, the illuminating means are of low-voltage type (e.g. 12V or 24V), and are connected in parallel. The illuminating means may be incandescent lamps, light emitting diodes, or electro-luminescent light sources, for example, or combinations of these.

Desirably, the illuminating means is covered by a lens or the like which is connected to the cover by proprietary fixings such as screws. In this way, a failed illuminating means can be easily removed and replaced, preferably by the publican without making a service call to an engineer.

Conveniently, the unit includes a support member for a drip tray, the support member being located underneath the tap. The support member has connecting means by which other support members may be connected thereto, so as to support adjacent drip trays for adjacent taps. In this way, the drip trays are also modular, and the number of drip trays can be chosen to match the number of dispense heads.

### BRIEF DESCRIPTION OF THE DRAWINGS

The invention will now be described, by way of example, with reference to the accompanying drawings, in which:

FIG. 1 shows an exploded view of the structural parts of the drinks dispenser;

FIG. 2 shows a rear view of a part of the drinks dispenser fitted with coolant manifolds;

FIG. 3 shows an exploded view of the cover components of the drinks dispenser;

FIG. 4 shows a view similar to that of FIG. 3, including illuminating means; and

FIG. 5 shows a view of the support means and drip trays.

### DESCRIPTION OF THE EXEMPLARY EMBODIMENTS

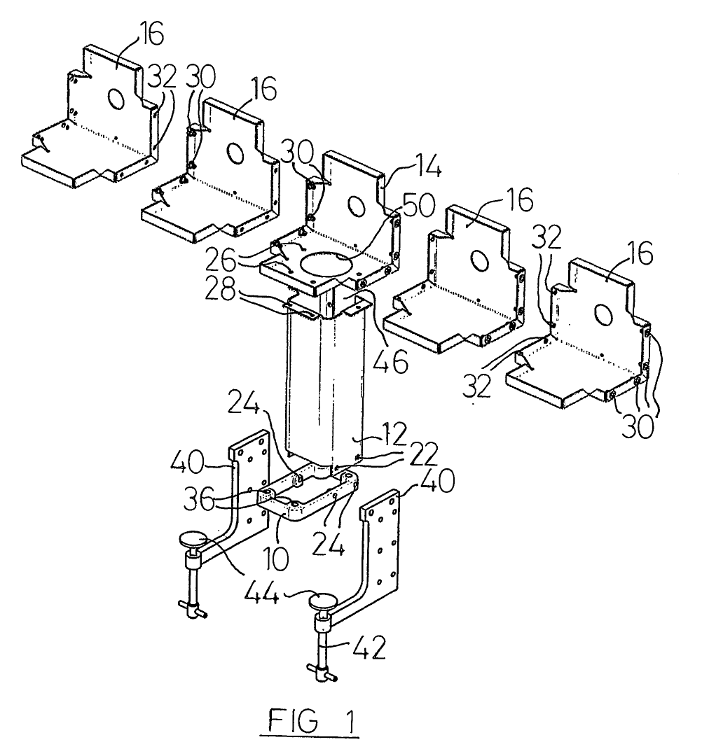

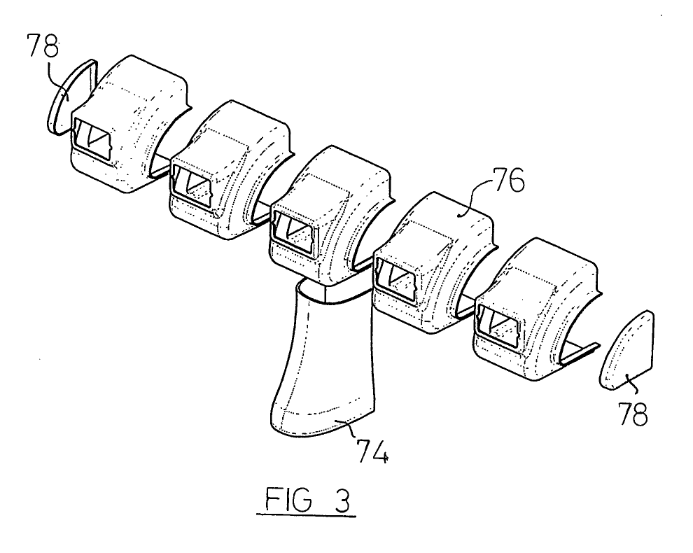

As shown in FIG. 1, the structural parts of the drinks dispenser include a counter-top fixing plate 10, a support column 12, a central dispense frame 14, and a number of modular dispense frames 16. In this embodiment the drinks dispenser is intended to have five dispense heads 20 (see FIG. 3), and so four frames 16 are provided. It will be understood that the number of modular dispense frames 16 can be none (so that the drinks dispenser has just a single tap 20 carried by the central frame 14), one, two, three or four, depending upon the number of dispense heads desired to be mounted thereupon. The addition (or reduction) of the number of modular dispense frames 16 mounted on the drinks dispenser can be undertaken at any chosen time, ideally by the publican without requiring the involvement of a service engineer.

The column 12 is secured to the fixing plate 10 by way of screws or bolts passing through aligned mounting holes 22, 24, there being two pairs of such holes, one pair to either side of the column (only three of the four mounting holes being visible in FIG. 1). Usefully, the mounting holes 24 are threaded.

The central frame 14 is secured to the column 12 by way of screws, bolts or the like passing through aligned mounting holes 26, 28. The mounting holes 28 can be threaded if desired, but in the embodiment shown are not threaded, so that a nut or other fastener is required to secure the frame 14 to the column 12.

In another embodiment the central frame is integral with the column.

The central frame 14 carries eight threaded studs 30, four to each side, and the modular frames 16 each have four mounting holes 32 to receive screws or bolts by which they may be secured to the frame 14. Each frame 16 also carries four threaded studs 30 by which an adjacent frame 16 can be mounted thereupon.

The fixing plate 10, column 12, and frames 14, 16 are all of metal, suitably stainless steel or aluminium, and are designed to be substantially rigid. Accordingly, when the structural parts described have been assembled together, a substantially rigid frame is provided which can support the weight of the remainder of the drinks dispenser, plus additional loads which may be placed upon it during use.

As will be described later on, in the preferred embodiment described the structural components shown in FIG. 1 are all hidden (at least from the customer's side of the counter) by suitable covers; a particular advantage of this arrangement over that of GB 2,178,729 is therefore the avoidance of the compromise that the structural strength and aesthetic appeal of the dispenser are both provided by the same components. In the present invention the structural strength and rigidity is provided by a metal frame which can be made suitably robust to withstand the loading required, substantially regardless of aesthetic considerations.

Also, the robust nature of the structural components allows an uneven mounting of the frames 16. For example, in a drinks dispenser having five dispense heads it may be desired to have one modular frame 16 to one side of the central frame 14, and three to the other side, or even none to one side and four to the other side. Thus, whilst it is generally aesthetically and structurally desirable to have the column located at (or as near as possible to) the centre of the array of dispense heads, this might not always be possible. For example, the column may need to be located upon the counter in a position where an uneven mounting of the frames is required, perhaps to avoid a wall or other drinks outlets. The structural components should be designed to facilitate such uneven installation if that is required.

Also, whilst the enclosed drawings relate to a drinks dispenser in which a column can mount up to five dispense heads to provide a discrete tower, more complex arrangements are possible, such as a “chain” of ten dispense heads all connected together and mounted on two columns which are spaced apart along the length of the chain. One possible arrangement having ten dispense heads and two columns would have the columns beneath the third and eighth dispense heads in the chain. Clearly, longer chains could be provided as desired, supported by an appropriate number of columns. The number of columns would depend upon the pipework contained within each column, i.e. if the columns contained five beer supply lines then one column would be required for every five dispense heads.

Clearly, more or fewer than five dispense heads can be served by a column, as desired.

If the drinks dispenser is to be secured directly to the top of the counter then the counter-top fixing bracket 10 is secured to the counter-top (not shown) by way of screws or the like passing through holes 36. FIG. 1 also shows a pair of optional clamping brackets 40, which may be secured to the column 12 and fixing bracket 10, in the event that the drinks dispenser is to be clamped to the counter. In such cases, the threaded bars 42 can be rotated so as to clamp the counter-top between the feet 44 and the underside of the fixing plate 10.

It will be noted that the column 12 is hollow, and in this embodiment has a partially open side 46 (which is the rear side in use, i.e. the side facing away from the customer). When the drinks dispenser is being installed, the structural components of FIG. 1 will be secured together (with the chosen number of modular frames 16) and secured or clamped to the counter-top. In addition, each frame 14, 16 will have a beer tap fitted thereto (it is normally desired that each frame 14, 16 be pre-fitted with a beer tap 20, to avoid the publican having to undertake that part of the assembly procedure).

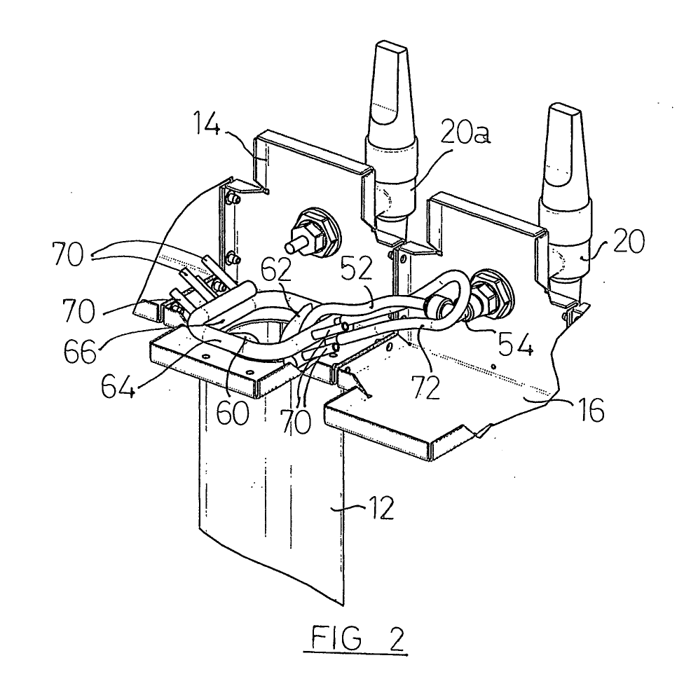

Each of the five beer supply lines (not shown, but which will usually be pre-existing and located underneath the counter top), can be passed through the fixing bracket 10, up through the column 12, through the opening 50 in the central frame 14, and into engagement with its respective tap 20 (FIG. 2 shows the connection between a beer supply line 52 and its respective tap 20). The open side 46 of the column 12 facilitates manipulation and fitment of the beer supply lines.

If the beer supply lines are fitted in this way, then a standard connector may be used to connect each beer supply line to its respective tap.

In an alternative and preferred arrangement, the drinks dispenser includes a number of conduits (such as the conduit 52 of FIG. 2) pre-installed within the column 12. The number of conduits is chosen to match that of the maximum number of dispense head which the particular drinks dispenser is designed to accommodate, in this embodiment five. One end of each conduit may be connected by suitable means to a respective beer tap (as shown in FIG. 2), and its other end connected to the pre-existing beer supply line (not shown) beneath the counter.

In the embodiment of FIG. 2, the tap 20 is a standard beer tap and has an elbow 54 connected thereto, the conduit 52 being connected to the elbow 54. The connections between the tap 20 and elbow 54, and elbow 54 and conduit 52, are John Guest(™) connectors in this embodiment, though other suitable liquid tight connectors could alternatively be used as desired.

Also shown in FIG. 2 is the coolant system by which the beer in conduit 52 may be cooled substantially all the way to the tap 20. In addition to the conduits 52 (only one of which is shown in FIG. 2), the column 12 carries a coolant supply pipe 60 and a coolant exhaust pipe 62. The coolant pipes are connected to a refrigeration system (not shown), which will typically recirculate cooled water around a circuit including the pipes 60 and 62.

The coolant supply pipe 60 is connected to a coolant supply manifold 64, and the coolant exhaust pipe 62 is connected to a coolant exhaust manifold 66. The manifolds 64 and 66 each have a number of (in this embodiment four) branches 70, which are capped when not in use, but which can be connected to a coolant pipe 72. As shown in FIG. 2, the coolant pipe 72 has one end connected to an (uncapped) branch of the coolant supply manifold 64, and its other end connected to an (uncapped) branch of the coolant exhaust manifold 66. In this way, coolant can flow up the coolant supply pipe 60, through the manifold 64, along the coolant pipe 72, into the manifold 66 and down the coolant exhaust pipe 62 to be re-cooled by the refrigeration system.

It will be seen that the coolant pipe 72 lies alongside the beer supply pipe 52 between the column 12 and the tap 20, so that beer within the beer supply pipe 52 is cooled substantially all of the way to the tap. In this way, the beer supplied to tap 20 can be kept cool even during long periods when none is dispensed, and little or no warm beer will subsequently be dispensed from the tap 20. Clearly, the coolant supply pipe 60 will cool the beer within the column 12.

In addition, the pipework would typically be insulated, e.g. covered by an insulating foam material, which is not shown for clarity.

Despite the drinks dispenser described being adapted for five taps 20, the manifolds 64 and 66 have only four branches 70. In this embodiment, the central beer tap 20a does not have a coolant supply because this is believed to be unnecessary, i.e. the central tap 20a is sufficiently close to the column 12 that additional cooling of the (very short) beer supply line (not shown) to the tap 20a is not required. Since the central frame 14 is permanently connected to the column 12, if it was desired to cool the beer all the way to the central tap 20a then a further coolant pipe could interconnect the coolant supply manifold 60 and the coolant exhaust manifold 62.

In this embodiment the taps 20 are “free-flow” taps in which beer flows whilst the tap is opened and stops once the tap is closed. Alternatively, the taps can be metered, dispensing a predetermined quantity of beer. Metered taps require a supply of electricity, and this can be communicated to the tap by cabling passing up the column 12, in known fashion.

As shown in FIG. 3, the drinks dispenser also includes a column support cover 74, a number of modular dispense support covers 76 (corresponding in number to the number of frames 14, 16), and a pair of end covers 78.

In addition, a backplate (not shown) is provided for the column 12, and separate back plates (also not shown) are provided for each of the dispense heads, the covers and backplates substantially enclosing the internals of the column and dispense heads.

The column support cover 74 is securable to its backplate, suitably by screws (not shown). Alternatively, the cover 74 may be clipped to the backplate, or else secured to the column 12.

The dispense support covers 76 are securable to their respective backplates, also by way of screws (not shown), but again may alternatively be clipped thereto, or else be secured to the respective frames 14, 16. The end covers 78 are securable to the end-most dispense covers 76, in this embodiment by screws (not shown) but alternatively may be clipped thereto.

Importantly, the styling, colouring and decoration of the covers 74, 76, 78 (and if desired also the backplates) can be designed to suit a particular drinks supplier. Thus, it will be understood that the covers 74, 76 and 78 are provided for aesthetic purposes only, and play little or no part in the structural strength or rigidity of the drinks dispenser.

Also, since each cover component is independent of the remainder of the cover components damage to one component does not require replacement (and may also not require removal) of other cover components. Also, since it is the covers 76 which carry the name, logo and other indicia identifying the beer which is dispensed through a particular dispense head, if that beer is changed it is relatively easy to change the cover to reflect the new beer to be dispensed. It is expected that the publican will be able to effect such a change without requiring a visit from a service engineer.

Furthermore, even if the beer being dispensed through a particular tap 20 is not to change it may be desirable to change the covers 76 (and also perhaps the covers 74 and 78), perhaps to update a logo or indicia, or to celebrate a particular occasion such as Christmas, when different colours and/or additional decoration might be desired.

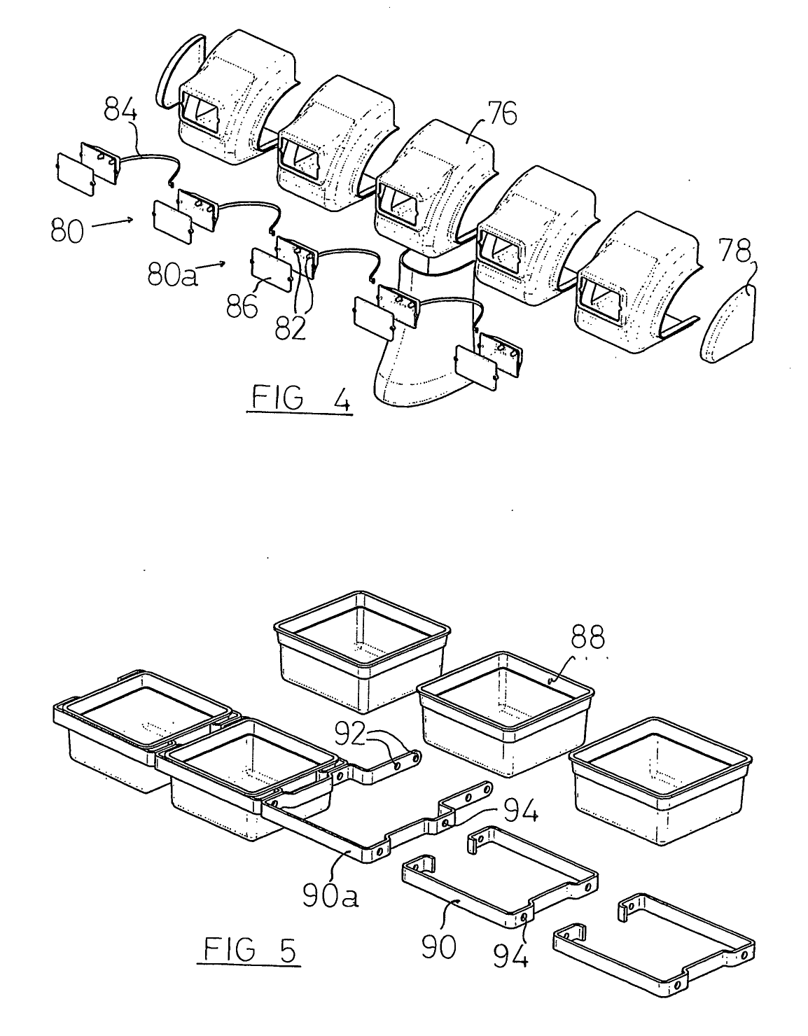

FIG. 4 shows the illuminating means for the drinks dispenser, which in this embodiment comprises discrete illuminating means 80 for each dispense head. The illuminating means 80 in this embodiment comprises a pair of light emitting diodes 82, but in other embodiments can comprise fewer or more light emitting diodes, one or more incandescent lamps, or one or more electro-luminescent light sources, as desired. The illuminating means is preferably arranged to operate at low voltage, for example 12V or 24V, such low-voltage supply often being available in public houses.

The illuminating means 80a which is carried by the central dispense head is connected to electrical supply wires (not shown) within the frame 14. Electricity is supplied to the illuminating means 80 of the other dispense heads by way of wires 84 which lie inside the covers 76 and so are obscured from view. Each illuminating means 80 is connected in parallel so that the same voltage is provided to each. Accordingly, each of the wires 84 comprises a pair of wires, one carrying current to the respective illuminating means, one carrying current away from the illuminating means.

Each illuminating means also includes a lens 86, each lens being securable (by way of screws or the like (not shown) to the respective cover 76. In this way, it is arranged that a failed illuminating means can be removed and replaced following removal of the lens, it being expected that the publican can undertake such a task without requiring service support.

The lens may be a flat piece of transparent glass or plastic, and will typically carry translucent indicia identifying the beer which is dispensed at that dispense head. Thus, the identifying indicia can be carried by the covers 76, the lenses 86, or both.

FIG. 5 shows the modular drip tray support arrangement, by which the drinks dispenser can have the requisite number of drip trays 88, one for each dispense head. In this embodiment, the central drip tray support 90a can be connected (by way of screws or the like passing through holes 92) to the clamping brackets 40. In embodiments not employing clamping brackets the central drip tray support can be secured to the column 12, either directly or by means of suitable bracketry. The central drip tray support 90a has holes 94 which can receive screws, bolts or the like, and can be used to connected adjacent drip tray supports 90 thereto. In this way, successive drip tray supports can be mounted to match the number (and configuration) of dispense heads in the drinks dispenser. Each of the drip tray supports 90, 90a are designed to accommodate a removable drip tray 88, which may be of standard design.

It will therefore be understood that a dispense head (comprising a frame 16, tap 20, and cover 76) can be removed from a drinks dispenser with relative ease, and without need to remove all of the remaining dispense heads. A dispense head may require to be removed for repair or replacement, or if it is no longer required. When a dispense head is removed and not replaced, its beer supply conduit 52 can also be removed, or can be left in place but plugged to prevent the ingress of dirt. If a coolant pipe is fitted for that dispense head that can be removed and the respective branches 70 plugged. The drip tray and its support can also be removed from the drinks dispenser.

It will also be understood that a dispense head can be added to an existing drinks dispenser, provided that the existing number of dispense heads does not equal the design maximum for that dispenser. To add a dispense head is also relatively easy and requires {i} the removal of the end cover 78, {ii} the removal of the cover 76 from the end-most existing dispense head, {iii} the securement of an additional frame 16, {iv} the removal of the dispense cover 76 from the central dispense head in order to expose the pipework within the column 12, {v} the connection of the beer supply conduit 52 and the coolant pipe 72 (if required), {vi} the fitment (and re-fitment) of the covers 76 and the end cover 78, {vii} the installation and connection of the illuminating means in the new dispense head, and {viii} the installation of another drip tray support and its associated drip tray.

The removal and addition of a dispense head is designed to be sufficiently easy for a publican to undertake, so avoiding the need for a service engineer.

It will therefore be understood that the advantages of the invented system include:
{a} greater flexibility in determining the number of dispense heads mounted upon a counter;
{b} ease of re-branding a dispense head to serve a different beer or if the indicia of that beer change—only the aesthetic components need changing and not the complete unit;
{c} the addition and reduction of the number of dispense heads, the re-branding of a particular dispense head, and the replacement of a damaged or faulty dispense head or its components can usually be undertaken without a service engineer;
{d} the publican or the brewery can maintain a stock of the component parts of the drinks dispenser so as to allow the assembly of a tower in many different configurations, at far lower cost than maintaining the required inventory for similar configurations of traditional tower drinks dispensers;
{e} should a part of the drinks dispenser become damaged, it is possible to replace only the damaged part or component(s), and not the whole of the tower.

The invention claimed is:

1. A drinks dispenser comprising a frame means carrying at least one tap, the frame means being connected to a column within which can be located a conduit for delivering liquid to the tap, the frame means having connecting means by which separate and additional frame means may be connected thereto, characterized in that a separate cover means is provided which can be mounted upon the frame means.

2. A drinks dispenser according to claim 1 in which the column is fitted with a plurality of conduits.

3. A drinks dispenser according to claim 2 in which each conduit is fitted with a connector at each of its ends so that its respective ends can be connected to a tap and to a liquid supply conduit.

4. A drinks dispenser according to claim 2 in which each conduit extends beyond the top of the column by a distance sufficient to permit connection to a respective tap of the dispenser, and extends beyond the bottom of the column by a distance sufficient to permit connection to a respective liquid supply conduit.

5. A drinks dispenser according to claim 1 having a coolant supply conduit and a coolant exhaust conduit, a part of the coolant supply conduit and a part of the coolant exhaust conduit being located within the column.

6. A drinks dispenser according to claim 5 having a coolant supply manifold connected to the coolant supply conduit and a coolant exhaust manifold connected to the coolant exhaust conduit, each manifold having a number of branch means to which a coolant conduit can be connected and through which coolant can pass.

7. A drinks dispenser according to claim 1 in which the or each of the frame means and additional frame means and/or the or each of the cover means carries illuminating means.

8. A drinks dispenser according to claim 7 in which the or each of the frame means and additional frame means and/or the or each of the cover means carries electrical wiring means to provide electricity to the illuminating means.

9. A drinks dispenser according to claim 7 in which the illuminating means are of low-voltage type, and the respective illuminating means are connected in parallel.

10. A drinks dispenser according to claim 1 including a support member for a drip tray, the support member being located underneath the tap, the support member having connecting means by which other support members may be connected thereto, so as to support respective drip trays for each of the taps.
